(19) United States
(12) Patent Application Publication
(10) Pub. No.: US 2014/0344655 A1
(43) Pub. Date: Nov. 20, 2014

(54) Mapping of Defined Regions Within a Webpage

(71) Applicants: Kevin D. McGushion, Simi Valley, CA (US); Christopher Mark Brahmer, Camarillo, CA (US); Pavel Kovalev, Ventura, CA (US)

(72) Inventors: Kevin D. McGushion, Simi Valley, CA (US); Christopher Mark Brahmer, Camarillo, CA (US); Pavel Kovalev, Ventura, CA (US)

(21) Appl. No.: 14/290,839

(22) Filed: May 29, 2014

Related U.S. Application Data
(60) Provisional application No. 61/806,805, filed on Mar. 29, 2013.

(51) Int. Cl. G06F 17/22

(52) U.S. Cl. CPC G06F 17/2247; G06F 17/2235
USPC 715/202

(57) ABSTRACT

The present invention provides a method of providing manipulated content to a user from a website page. The method identifies the location and size of defined regions within a website page, such as document division elements. The site page is built on a virtual display, and a site page coordinate system is established to locate the defined region relative to an origin. The site page is then converted to an image file, where an image file coordinate system corresponds to the site page coordinate system to permit the locating and mapping of the defined regions images on the image file, for cropping and so that the original hyperlinks can be reassociated with the defined regions images. Individual defined regions images in cropped form may be communicated to and positioned on a user interface. An updated image may compared with the original image to determine if the content has changed.

### RELATED APPLICATION DATA

This application claims the priority date of provisional application No. 61/806,805 filed on Mar. 29, 2013.

### BACKGROUND

The present method relates to methods of detecting and manipulating defined regions within web pages, and more particularly, to a method of consolidating web pages by periodically collecting data from a user-selected group of web resources for display to the user.

Webpages are often comprised of multiple defined regions of structured elements, such as a document division elements or “divs” (indicated by the <div> tag in HTML). The defined regions permit organization of the content in blocks, where each block may contain a specific content, links, or a div within a div, etc. News webpages especially utilize defined regions, with each block potentially displaying a headline, an article teaser, one or more hyperlinks, contact information, and the like. Alternatively, a webpage may contain a large defined region with a single, complete article, surrounded by blocks containing internal site links, advertising, and similar information related or unrelated to the main article.

What is needed is a means to detect and define the location of defined regions within a webpage for manipulation and conversion to more readable and understandable forms; and, ultimately, delivery to an end user in a desired format.

### SUMMARY OF THE INVENTION

A method of mapping of defined regions within a webpage is described herein. The steps of the method of providing content to a user includes communicating a resource address from a user input on a local computing device to a web browser instance on a remote server. Then, building a site page associated with the resource address within the web browser instance and detecting a site page code indicative of a defined region within the site page. Next, storing a boundary and a coordinate of the defined region relative to an origin. At least a portion of the site page that at least includes the defined region is converted into an image file, where the image file is visually representative of the portion of the site page. A position is defined on the image file which substantially corresponds to the coordinate of the defined region. An area on the image file is defined which includes the position and substantially corresponds to the boundary of the defined region. At least part of the image file is stored on the remote server, with the position and the area data, such that a defined region image portion can be located on the part of the image file.

The coordinate of the defined region comprises a horizontal coordinate and a vertical coordinate, the horizontal coordinate defining a horizontal pixel count from the origin and the vertical coordinate defining a vertical pixel count from the origin, the method further comprising the steps of:
assigning a screen resolution to a virtual screen;
assigning a location for the origin on the virtual screen for a site page coordinate system;
locating the horizontal coordinate and the vertical coordinate of the defined region relative to the origin; and
storing the horizontal pixel count of the horizontal coordinate and the vertical pixel count of the vertical coordinate on the remote server.

The boundary comprises a pixel height count and a pixel width count of the defined region, the boundary including the coordinate of the defined region, the method further comprising the step of:
storing the pixel height count and the pixel width count on the remote server.

An image resolution of the image file corresponds to the screen resolution of the virtual screen, and wherein an image coordinate system corresponds to the site page coordinate system, the method further comprising the steps of:
associating the horizontal pixel count and the vertical pixel count with the part of the image file to locate the defined region image portion within the part of the image file; and
associating the pixel height count and the pixel width count with the part of the image file to determine the area of the defined region image portion.

Alternative steps may include defining a crop boundary on the part of the image file, the crop boundary being defined on the part of the image file by the horizontal pixel count, the vertical pixel count, the pixel width count, and the pixel height count; cropping the part of the image file at the crop boundary to create a cropped image file containing at least the defined region image portion; and storing the cropped image file on the remote server.

Alternative steps may include communicating the cropped image file to the local computing device; and displaying the cropped image file on a screen of the local computing device. Alternative steps may include defining a user coordinate system within a graphical user interface on the local computing device; positioning the cropped image file to a desired coordinate on the graphical user interface; storing an association between the desired coordinate and the cropped image file on the server.

Alternative steps may include
communicating again the resource address to the web browser instance;
building an updated site page associated with the resource address within the web browser instance;
detecting an updated defined region similarly with the boundary and the coordinate of the defined region;
converting at least an updated portion of the updated site page that at least includes the updated defined region into an updated image file, the updated image file being visually representative of the updated portion of the updated site page;
defining the position on the updated image file which substantially corresponds to the coordinate of the updated defined region;
defining the area on the image file which includes the position and substantially corresponds to the boundary of the defined region; and
storing at least an updated part of the updated image file, the updated position, and the updated area on the remote server, such that an updated defined region image portion can be located on the part of the image file.

Alternative steps may include defining the crop boundary on the updated part of the updated image file, the updated crop boundary being defined on the updated part of the updated image file by the horizontal pixel count, the vertical pixel count, the pixel width count, and the pixel height count; cropping the updated part of the updated image file at the crop boundary to create an updated cropped image file containing the updated defined region image portion; and storing the updated cropped image file on the remote server.

Alternative steps may include converting the cropped image file into a hash value; converting the updated cropped image file into an updated hash value; and comparing the hash value to the updated hash value to determine if the hash value is different than the updated hash value due to a content change within the boundary and the coordinate. Alternatively, the defined region is a document division element.

Alternative steps may include:
detecting the presence of a hyperlink with a resource address link within the defined region;
creating a local coordinate system with a local origin within the defined region;
detecting a hyperlink coordinate and a hyperlink boundary relative to the local origin, the hyperlink boundary enclosing at least a section of a text or a graphic associated with the hyperlink; and
storing the hyperlink coordinate and the hyperlink boundary on the local server.

Alternatively, the hyperlink coordinate within the defined region comprises a horizontal hyperlink coordinate and a vertical hyperlink coordinate, the horizontal hyperlink coordinate defining a horizontal hyperlink pixel count from the local origin and the vertical hyperlink coordinate defining a vertical hyperlink pixel count from the local origin, and wherein the hyperlink boundary comprises a hyperlink pixel height count and a hyperlink pixel width count of the defined region, where alternative steps may include:
assigning a screen resolution for a virtual screen;
assigning a location of the origin on the virtual screen;
locating the local origin relative to the origin;
locating the horizontal hyperlink coordinate and the vertical hyperlink coordinate of the hyperlink relative to the local origin within the defined region;
assigning the hyperlink pixel height count and the hyperlink pixel width count;
storing the horizontal hyperlink pixel count, the vertical hyperlink pixel count, the hyperlink pixel height count, and the hyperlink pixel width count on the remote server, such that a hyperlink image portion can be located on the defined region image portion and so that the resource address link can be associated with the hyperlink image portion.
   Alternatively, an image resolution of the image file corresponds to the screen resolution of the virtual screen, the method further comprising the steps of:
associating the horizontal pixel count and the vertical pixel count with the part of the image file to locate the defined region image portion within the part of the image file;
associating the pixel height count and the pixel width count with the part of the image file to determine the area of the defined region image portion;
defining a hyperlink position on the hyperlink image portion which substantially corresponds to the hyperlink coordinate;
defining a hyperlink area on the image file which includes the position and substantially corresponds to the hyperlink boundary;
associating the horizontal hyperlink pixel count and the vertical hyperlink pixel count with defined region image portion to locate the hyperlink position within the defined region image portion; and
associating the hyperlink pixel height count and the hyperlink pixel width count with defined region image portion to determine the hyperlink area.

Optionally, the local origin is the coordinate of the defined region. Optionally, the hyperlink is a hypertext, the hyperlink boundary enclosing at least the section of the hypertext. Optionally, the hyperlink is a hypergraphic, the hyperlink boundary enclosing at least the section of the hypergraphic. Optionally, the resource address link is associated with the hyperlink image portion, such that selecting the hyperlink image portion causes navigation to a site associated with the resource address link.

### BRIEF DESCRIPTION OF THE SEVERAL VIEWS OF THE DRAWINGS

Additional objects and features if the method will be more readily apparent from the following detailed description and appended claims when taken in conjunction with the drawings, in which:

FIGS. 1A-B illustrate a typical site page within a web browser instance, schematically showing multiple defined regions;

FIGS. 2A-B illustrate the image resulting from the conversion of the site page into an image file, with selected defined regions described;

FIGS. 3A-C illustrate the detection of hyperlinks within an example defined region through the image conversion process;

FIGS. 4A-C illustrate the detection of hyperlinks within another example defined region through the image conversion process;

FIG. 5 illustrates an example local computing device screen upon which several example defined regions are positioned; and

FIGS. 6A-B illustrate the comparison of a cropped image with an updated cropped image.

### LISTING OF REFERENCE NUMERALS OF FIRST-PREFERRED EMBODIMENT

web browser instance 20
virtual screen 21
site page 22
header 24
navigation bar 26
page background 28
canvas 30
main content 32
first defined region 34
first subregion 36
second subregion 38
second defined region 40
third defined region 42
defined regions 44-56
origin 58
first boundary 60
first coordinate 61
second boundary 62
second coordinate 63
third boundary 64
third coordinate 65
horizontal pixel count 66
vertical pixel count 68
graphic 70
updated graphic 72
image file 74
first defined region image portion 76
second defined region image portion 78
third defined region image portion 80
first subregion image portion 82
second subregion image portion 84
first area 86
second area 88
third area 90
first position 92
second position 94
third position 96
first subregion image position 98
second subregion image position 100
first subregion area 102
second subregion area 104
first boundary width w1
first boundary height h1
second boundary width w2
second boundary height h2
third boundary width w3
third boundary height h3
first cropped image 106
second cropped image 108
third cropped image 110
updated cropped image 112
local computing device screen 114
user system origin 116
first user coordinate 118
second user coordinate 120
third user coordinate 122
user interface background 124
third hypertext link 126
second hypertext link 127
hypergraphic link 128
external link 130
article excerpt 132
article excerpt 134
third hyperlink boundary 136
second hyperlink boundary 138
graphic hyperlink boundary 140
hyperlink coordinate 142, 144, 146
hyperlink image portion 148, 150, 152
updated site page 154

### DESCRIPTION OF THE PREFERRED EMBODIMENTS

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

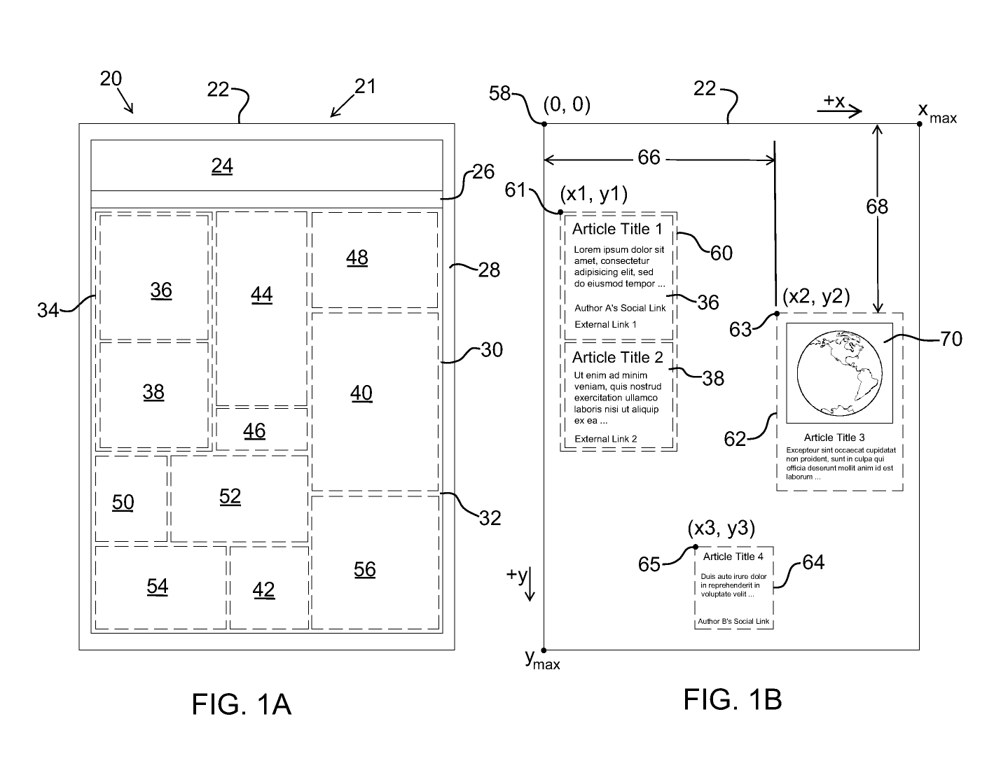

Accordingly, the present method provides content to a user from a site page (22) built within a web browser instance (20) on a virtual screen (21) or an actual screen. A simplified example site page (22) is illustrated in schematic form in FIGS. 1A-B, with a header (24) generally found at the top of the canvas (30) portion of the site page (22), with a navigation bar (26) with various internal links usually found beneath the header (24). The canvas (30) is generally positioned over the page background (28). Within the main content area (32) are a plurality of defined regions (34-56). Although the defined regions (34-56) are shown in rectangular block form, various shaped regions are possible, such as regions which may be created to match a complex boundary of a graphic (e.g., a map, etc.). Within each defined region (34-56) there may be displayed a headline, an article teaser, one or more hyperlinks, contact information, and the like.

In particular, and to simplify the example, three defined regions (34, 40, 42) will be explored according to the method. However, the method described in reference to defined regions (34, 40, 42) may be utilized to manipulate, modify, and convert the remaining defined regions (44-56) similarly. Specifically, FIG. 1B illustrates the detection and measurement of the three example defined regions (34, 40, 42) within the site page (22), as would be displayed on a virtual screen (21). The virtual screen (21) emulates an actual monitor screen utilizing software, such as an instruction that the computer, such as a server, is connected to the actual monitor screen with an assigned display resolution in pixels. The screen resolution may be fixed, such as 1440 pixels×900 pixels. Preferably, the screen resolution is variable, at least in part, to match the pixel dimensions of the site page (22). For example, the width of the virtual screen may be fixed at 1440 pixels, and the height varies according to the pixel height of the site page (22) or, for lengthy pages, a maximum pixel height may be implemented, truncating a portion of the site page (22). Page down, page up, and similar commands may be emulated to cause the entire length of the site page (22) below the fold to load. Thus, for most site pages (22), the entire length (to yₘₐₓ) is loaded and built, so that the image file (74) is an image representative of the entire width and length of the site page (22).

Within the HTML code (or other code used in website design) are indicators of defined regions, such as the example div block with an internal hyperlink <div id=“Article1” div style=“height:125px; width:75px”><a href=“http://webaddress.com” target=“_blank”>Article 1 Title</a></div>. This example code would display a defined region with a dimension of 125 pixels high and 75 pixels wide. Alternatively, CSS can be used to set various styles and dimensions. The text within the defined region would be “Article 1 Title”. By clicking on the text, the browser will be directed to the link (webaddress.com) within a new browser instance. Thus, by exploring the known parameters of each defined region and the surrounding defined regions, the width, height, and location of the defined region can be determined and recorded as a pixel dimension on a Cartesian coordinate system.

Looking more closely at FIG. 1B, the first defined region (34) has a first boundary (60) with a first coordinate (61) in the upper left corner and is indicated by x1 and y1, although any point may be selected for the first coordinate. The second defined region (40) has a second coordinate (63) and a second boundary (62). The second coordinate (63) (x2, y2) is located relative to the origin (58) by a horizontal pixel count (66) and a vertical pixel count (68). The first defined region (34) has a first subregion (36) and a second subregion (38) within the first boundary (60).

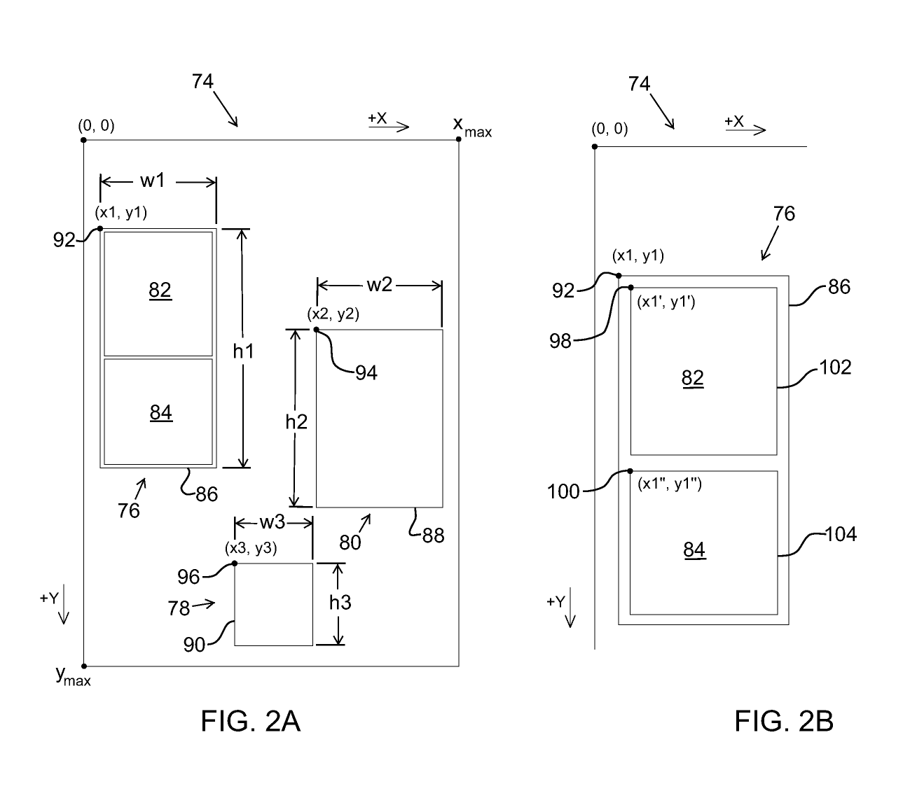

Looking at FIGS. 2A-B, the site page (22) has been converted into an image file (74), with an image origin at the upper left corner which corresponds to the site page origin (58). The xₘₐₓ and the yₘₐₓ dimension of the image file (74) matches the xₘₐₓ and the yₘₐₓ dimension of the site page (22), although the dimension of the image file (74) may be smaller or larger than the dimension of the site page (22) in alternate examples. The first position (92) of the first defined region image portion (76) is bounded by the first area (86) which directly corresponds to the size of the first boundary (60). The first boundary width (w₁) and the first boundary height (h₁) are illustrated by dimensions. FIG. 2B is a magnified view of the image file (74), detailing the first defined region image portion (76), with the first subregion image portion (82) with first subregion area (102) and the second subregion image portion (84) with the second subregion area (104), both within the first area (86). The first subregion image portion (82) has a first subregion image position (98), indicated as (x1′, y1′). The second subregion image portion (84) has a second subregion image position (100), indicated as (x1″, y1″). The first position (92) is generally a Cartesian coordinate with a pixel unit and the origin (0, 0), where the image origin preferably matches the location of the site page origin (58), so that the dimensions found in the code can be ultimately matched to and overlaid on the image file (74).

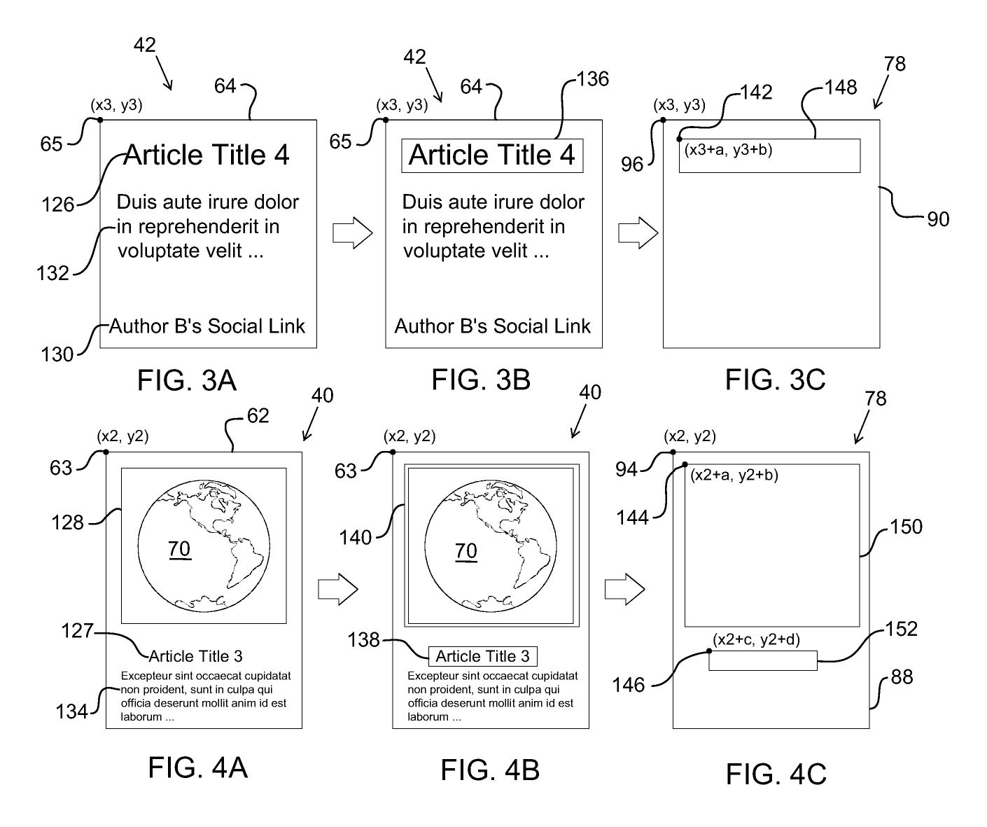

FIGS. 3A-C show the conversion of the third defined region (42) to an image (78) with the origin (96) indicated as (x3, y3), as shown in FIG. 3C. The text associated with the third hypertext link (126) is enclosed with a third hyperlink boundary (148) with a hyperlink coordinate (142) indicated as (x3+a, y3+b), which locates a clickable link on the image file which corresponds to the image of the third hypertext link (126). The external link (130) is ignored, due to a resource address differing from the site page (22) address. Likewise, the hyperlink image portions (150, 152) are associated with graphic (70) and second hyperlink text (127) respectively, and have clickable regions on the image portion (150 and 152).

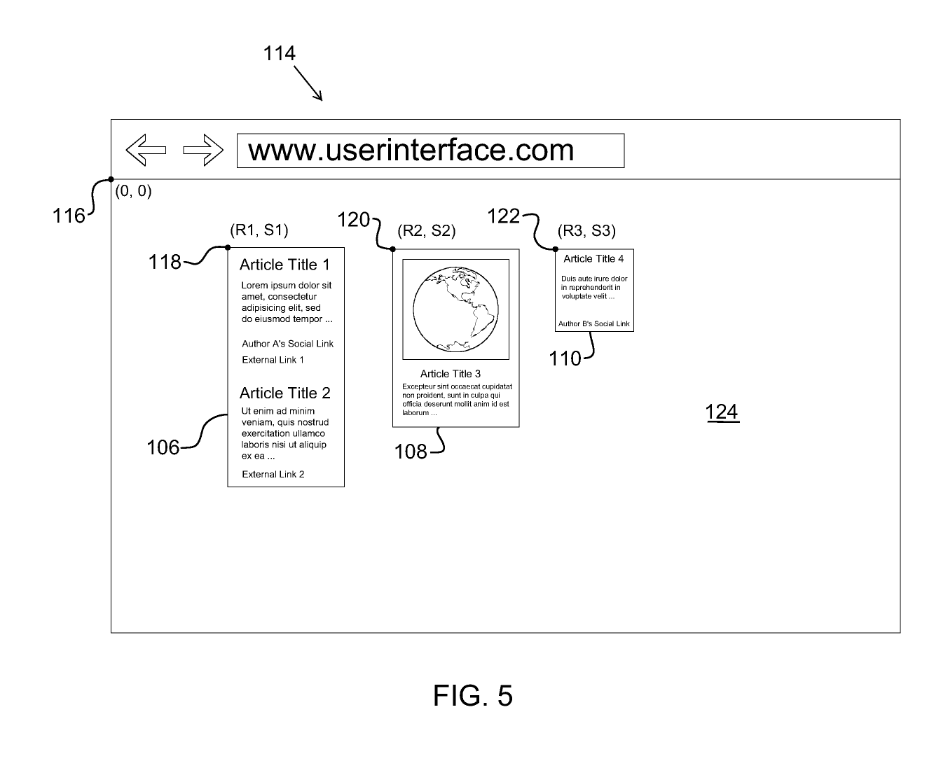

FIG. 5 shows the local computing device screen (114) with the cropped images (106, 108, 110) positioned on the background for display to a user. The user selects the position of the cropped images (106, 108, 110) by known methods, such as selecting the image with the cursor and moving it to a desired location or entering a coordinate. The user coordinates (118, 120, 122) can be stored on the local computer and also on the server.

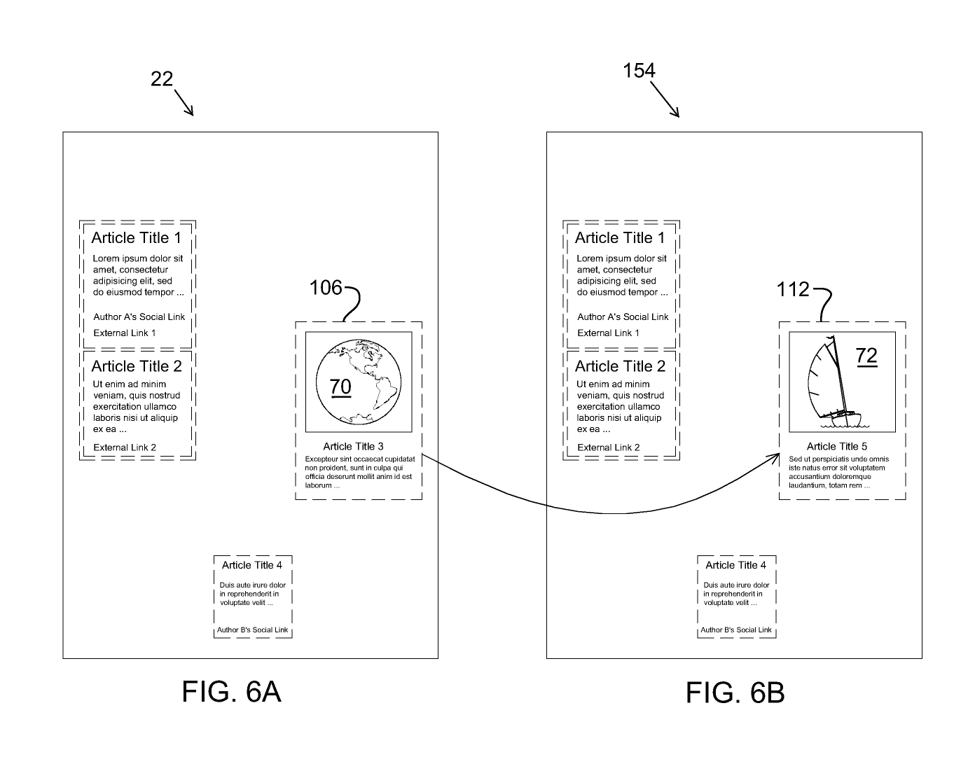

FIGS. 6A-B illustrates a method of comparing the site page (22) to the updated site page (154), where the defined region represented by the first cropped image (106) is compared to the later in time defined region represented by the updated cropped image (112) to detect changes in content. Further, the graphic (70) can be compared to the updated graphic (72) to determine if the image within the defined region has changed.

What is claimed is:

1. A method of providing content to a user, the method comprising the steps of:
communicating a resource address from a user input on a local computing device to a web browser instance on a remote server;
building a site page associated with the resource address within the web browser instance;
detecting a site page code indicative of a defined region within the site page;
storing a boundary and a coordinate of the defined region relative to an origin;
converting at least a portion of the site page that at least includes the defined region into an image file, the image file being visually representative of the portion of the site page;
defining a position on the image file which substantially corresponds to the coordinate of the defined region;
defining an area on the image file which includes the position and substantially corresponds to the boundary of the defined region; and
storing at least a part of the image file, the position, and the area on the remote server, such that a defined region image portion can be located on the part of the image file.

2. The method of claim 1, wherein the coordinate of the defined region comprises a horizontal coordinate and a vertical coordinate, the horizontal coordinate defining a horizontal pixel count from the origin and the vertical coordinate defining a vertical pixel count from the origin, the method further comprising the steps of:
assigning a screen resolution to a virtual screen;
assigning a location for the origin on the virtual screen for a site page coordinate system;
locating the horizontal coordinate and the vertical coordinate of the defined region relative to the origin; and
storing the horizontal pixel count of the horizontal coordinate and the vertical pixel count of the vertical coordinate on the remote server.

3. The method of claim 2, wherein the boundary comprises a pixel height count and a pixel width count of the defined region, the boundary including the coordinate of the defined region, the method further comprising the step of:
storing the pixel height count and the pixel width count on the remote server.

4. The method of claim 3, wherein an image resolution of the image file corresponds to the screen resolution of the virtual screen, and wherein an image coordinate system corresponds to the site page coordinate system, the method further comprising the steps of:
associating the horizontal pixel count and the vertical pixel count with the part of the image file to locate the defined region image portion within the part of the image file; and
associating the pixel height count and the pixel width count with the part of the image file to determine the area of the defined region image portion.

5. The method of claim 4, further comprising the steps of:
defining a crop boundary on the part of the image file, the crop boundary being defined on the part of the image file by the horizontal pixel count, the vertical pixel count, the pixel width count, and the pixel height count;
cropping the part of the image file at the crop boundary to create a cropped image file containing at least the defined region image portion; and
storing the cropped image file on the remote server.

6. The method of claim 5, further comprising the steps of:
communicating the cropped image file to the local computing device; and
displaying the cropped image file on a screen of the local computing device.

7. The method of claim 6, further comprising the steps of:
defining a user coordinate system within a graphical user interface on the local computing device;
positioning the cropped image file to a desired coordinate on the graphical user interface;
storing an association between the desired coordinate and the cropped image file on the server.

8. The method of claim 6, further comprising the steps of:
communicating again the resource address to the web browser instance;
building an updated site page associated with the resource address within the web browser instance;
detecting an updated defined region similarly with the boundary and the coordinate of the defined region;
converting at least an updated portion of the updated site page that at least includes the updated defined region into an updated image file, the updated image file being visually representative of the updated portion of the updated site page;
defining the position on the updated image file which substantially corresponds to the coordinate of the updated defined region;
defining the area on the image file which includes the position and substantially corresponds to the boundary of the defined region; and
storing at least an updated part of the updated image file, the updated position, and the updated area on the remote server, such that an updated defined region image portion can be located on the part of the image file.

9. The method of claim 8, further comprising the steps of:
defining the crop boundary on the updated part of the updated image file, the updated crop boundary being defined on the updated part of the updated image file by the horizontal pixel count, the vertical pixel count, the pixel width count, and the pixel height count;
cropping the updated part of the updated image file at the crop boundary to create an updated cropped image file containing the updated defined region image portion; and
storing the updated cropped image file on the remote server.

10. The method of claim 9, further comprising the steps of:
converting the cropped image file into a hash value;
converting the updated cropped image file into an updated hash value; and
comparing the hash value to the updated hash value to determine if the hash value is different than the updated hash value due to a content change within the boundary and the coordinate.

11. The method of claim 1, wherein the defined region is a document division element.

12. The method of claim 1 further comprising the steps of:
detecting the presence of a hyperlink with a resource address link within the defined region;
creating a local coordinate system with a local origin within the defined region;
detecting a hyperlink coordinate and a hyperlink boundary relative to the local origin, the hyperlink boundary enclosing at least a section of a text or a graphic associated with the hyperlink; and
storing the hyperlink coordinate and the hyperlink boundary on the local server.

13. The method of claim 12, wherein the hyperlink coordinate within the defined region comprises a horizontal hyperlink coordinate and a vertical hyperlink coordinate, the horizontal hyperlink coordinate defining a horizontal hyperlink pixel count from the local origin and the vertical hyperlink coordinate defining a vertical hyperlink pixel count from the local origin, and wherein the hyperlink boundary comprises a hyperlink pixel height count and a hyperlink pixel width count of the defined region, the method further comprising the steps of:
assigning a screen resolution for a virtual screen;
assigning a location of the origin on the virtual screen;
locating the local origin relative to the origin;
locating the horizontal hyperlink coordinate and the vertical hyperlink coordinate of the hyperlink relative to the local origin within the defined region;
assigning the hyperlink pixel height count and the hyperlink pixel width count;
storing the horizontal hyperlink pixel count, the vertical hyperlink pixel count, the hyperlink pixel height count, and the hyperlink pixel width count on the remote server, such that a hyperlink image portion can be located on the defined region image portion and so that the resource address link can be associated with the hyperlink image portion.

14. The method of claim 13, wherein an image resolution of the image file corresponds to the screen resolution of the virtual screen, the method further comprising the steps of:
associating the horizontal pixel count and the vertical pixel count with the part of the image file to locate the defined region image portion within the part of the image file;
associating the pixel height count and the pixel width count with the part of the image file to determine the area of the defined region image portion;
defining a hyperlink position on the hyperlink image portion which substantially corresponds to the hyperlink coordinate;
defining a hyperlink area on the image file which includes the position and substantially corresponds to the hyperlink boundary;
associating the horizontal hyperlink pixel count and the vertical hyperlink pixel count with defined region image portion to locate the hyperlink position within the defined region image portion; and
associating the hyperlink pixel height count and the hyperlink pixel width count with defined region image portion to determine the hyperlink area.

15. The method of claim 14, wherein the local origin is the coordinate of the defined region.

16. The method of claim 14, wherein the hyperlink is a hypertext, the hyperlink boundary enclosing at least the section of the hypertext.

17. The method of claim 14, wherein the hyperlink is a hypergraphic, the hyperlink boundary enclosing at least the section of the hypergraphic.

18. The method of claim 13, wherein the resource address link is associated with the hyperlink image portion, such that selecting the hyperlink image portion causes navigation to a site associated with the resource address link.
